(19) United States
(12) Patent Application Publication
(10) Pub. No.: US 2026/0204850 A1
(43) Pub. Date: Jul. 16, 2026

(54) ELECTRICAL CONNECTOR

(71) Applicant: LEMO SA, Ecublens (CH)

(72) Inventors: Savino Storione, Versoix (CH); Luc Burdet, St-Barthélemy (CH); Jacques Miéville, Morrens (CH)

(73) Assignee: LEMO SA, Ecublens (CH)

(21) Appl. No.: 19/135,846

(22) PCT Filed: Dec. 1, 2023
(86) PCT No.: PCT/EP2023/083856

§ 371 Date: Jun. 5, 2025

(30) Foreign Application Priority Data
Dec. 6, 2022 (EP) 22211796.2

(51) Int. Cl. H01R 24/86; H01R 13/53; H01R 43/20

(52) U.S. Cl. CPC H01R 24/86; H01R 13/53; H01R 43/20

(57) ABSTRACT

Electrical connector including an insulating housing having contact receiving cavities extending between a mating side and a cabling side of the housing, a plurality of electrical contacts lodged in the contact receiving cavities, the electrical contacts having a plugging end section, a center body section a wiring end section projecting out of the housing beyond the cabling side for connection to conductors of electrical wires, and an insulating tube sleeve slidably inserted over the electrical wire and having a section extending into the cabling side tube receiving section and a section extending out of the housing beyond the cabling side overlying an insulating layer on the conductor. The contact receiving cavity includes a cabling side tube receiving section having a diameter greater than a portion of the electrical contact so as to form a tubular gap between the electrical contact and the housing.

The present invention relates to an electrical connector.

There are many applications which require electrical contacts with a high contact density or compact arrangement, whereby the distance between contacts is dependent inter alia on the specified voltage difference between the contacts taking into account the safety margins necessary for the specified application. Electrical connectors typically have insulating housings with cavities in which the electrical contacts are lodged and held apart. Within the housing, the contacts are separated by the insulating material of the housing, however on the cabling side and on the mating side of the connector where portions of the contacts may extend out of the housing, the electrical path between electrical contacts is reduced such that electrical breakdown may occur between contacts outside of the housing.

In mating connectors, typically the male or pin contact projects out of the mating side of a connector housing whereas in the complementary connector, in which receptacles are lodged, the mating side of the receptacle contacts are within the insulating housing. Upon plugging connection, the pin contacts are inserted in the receptacle contacts and are thus separated by the insulating housing of the receptacle contacts, except for an interface between the housings of the mating connectors.

To increase the electrical path and thus the resistance to electrical breakdown, it is known to overmold a section of the pin contacts that is configured to the inserted into the cavities of the insulating housing of the mating connector in the plugged configuration, such that the electrical path is increased. Overmolding a section of contact extending from the mating side of an electrical connector is an expensive and complex technique in view of the molds required for ensuring the injection of material around the contacts. Moreover, the thickness of the insulating layer molded over a contact is very difficult to control with a high accuracy required to ensure that there is a sufficient layer of insulating material to avoid electrical breakdown through the insulating material layer.

On the cabling side, it is known to fill the spaces between the electrical contacts with an insulating resin or potting material after the contacts have been connected to conducting wires of a cable by various known means, for instance crimping, soldering, or welding. Care however needs to be taken to avoid air bubbles in the resin or potting material since any bubble between electrical contacts could lead to a short electrical path.

It is also known to install shrink-fit tubes around contacts to provide an insulating layer, but these also suffer from inhomogeneous thicknesses and electrical insulation properties. Also, the longitudinal positioning of the sleeve can vary slightly due to the somewhat uncontrolled shrinking of the tube. Separate assembly of sleeves on contacts after they have been assembled in a housing in conventional solutions do not provide consistently accurate axial positioning and/or thicknesses allowing to reduce the connector size and spacing between contacts to a theoretical minimum for the materials, voltage and geometry of a connector.

There is therefore a need, in particular for demanding applications requiring very compact connectors and high reliability and safety, to ensure that the connector has a specification to withstand a high relative voltage difference in a consistent, safe and reliable manner.

In view of the foregoing, it is an object of this invention to provide an electrical connector that is compact yet can withstand a high voltage difference between electrical contacts in a consistent, reliable manner.

It is advantageous to provide an electrical connector that is economical to produce and assemble.

In certain applications, it is advantageous to provide an electrical connector that has a high contact density yet can carry high voltage electrical signals in a safe and reliable manner.

It is advantageous to provide a high density electrical connector that has a well defined or well controlled plugging force.

Objects of this invention have been achieved by providing an electrical connector according to claim 1. Dependent claims set forth various advantageous features of embodiments of the invention.

Disclosed herein is an electrical connector comprising an insulating housing having contact receiving cavities extending between a mating side and a cabling side of the housing, a plurality of electrical contacts lodged in the contact receiving cavities and anchored in direct contact engagement with the contact receiving cavities, the electrical contacts having a plugging end section, a center body section and a wiring end section, the wiring end section projecting out of the housing beyond the cabling side for connection to conductors of electrical wires.

The contact receiving cavity comprises a cabling side tube receiving section having a diameter greater than a portion of the electrical contact so as to form a tubular gap between the electrical contact and the housing, the connector further comprising an insulating tube sleeve slidably inserted over the electrical wire, the insulating sleeve tube having a section extending into the cabling side tube receiving section and a section extending out of the housing beyond the cabling side overlying an insulating layer on the conductor.

In an advantageous embodiment, the insulating tube sleeve is made of polyimide.

In an advantageous embodiment, the connector further comprises an insulating filler deposited over the cabling side of the housing in between and around the insulating tube sleeves inserted in the cabling side tube receiving section of the housing.

In an advantageous embodiment, the connector further comprises a filler containment ring mounted around the cabling side of the housing forming a well for injection, pouring or molding of the insulating filler.

In an advantageous embodiment, a length of the insulating tube sleeve is at least eight times a distance between adjacent contacts.

In an advantageous embodiment, the contact comprises a mating section extending beyond a mating side of the housing and a reduced diameter body section having a rearwardly facing shoulder, the contact further comprising a second insulating tube sleeve having a length inserted over the reduced diameter center body section, a portion of the insulating tube sleeve extending beyond a mating side of the housing, configured for insertion in a contact receiving cavity of a mating connector.

In an advantageous embodiment, the diameter of a portion of the contact adjacent of the shoulder is substantially identical to a diameter of the second insulating tube sleeve such that the second insulating tube sleeve is flush with the contact at the interface between the insulating tube sleeve and the shoulder.

In an advantageous embodiment, the electrical contacts include pin contacts, wherein the pin contact comprises the reduced diameter body section having a rearwardly facing shoulder and the second insulating tube sleeve inserted over the reduced diameter center body section, the portion of the second insulating tube sleeve having a length of the second insulating tube sleeve extending beyond a mating side of the housing, configured for insertion in a receptacle contact receiving cavity of a mating connector.

In an advantageous embodiment, the receptacle contacts having a plugging end section positioned within the receptacle contact receiving cavity of the second housing spaced at a first length from a mating side of the second housing, said first length being at least two times a diameter of the receptacle contact receiving cavity.

In an embodiment, the electrical contacts include receptacle contacts, wherein the receptacle contact comprises the reduced diameter body section having a rearwardly facing shoulder and the second insulating tube sleeve inserted over the reduced diameter center body section, the portion of the second insulating tube sleeve having a length of the second insulating tube sleeve extending beyond a mating side of the housing, configured for insertion in a pin contact receiving cavity of a mating connector.

In an advantageous embodiment, the insulating tube sleeves have a tube wall thickness of less than 0.3 mm.

Also disclosed herein is an electrical connector arrangement comprising a first connector and a second connector pluggably connectable together, the first connector and second connector having the characteristics of the electrical connector according to any one or more of the above embodiments wherein the first connector comprises pin contacts and the second connector comprises receptacle contacts.

Also disclosed herein is a method of assembling an electrical connector according to any of the preceding embodiments, comprising
inserting or overmolding the electrical contacts in the insulating housing,
inserting the insulating tube sleeves over at least some of the electrical wires,
connecting the conductors of the wires to the respective wire receiving portions of the contacts,
sliding the insulating tube sleeves over the respective wire receiving portions of the contacts and into the contact receiving cavities,
depositing an insulating filler over the cabling side of the housing in between and around the insulating tube sleeves.

Further objects and advantageous features of the invention will be apparent from the claims, from the detailed description, and annexed drawings, in which:

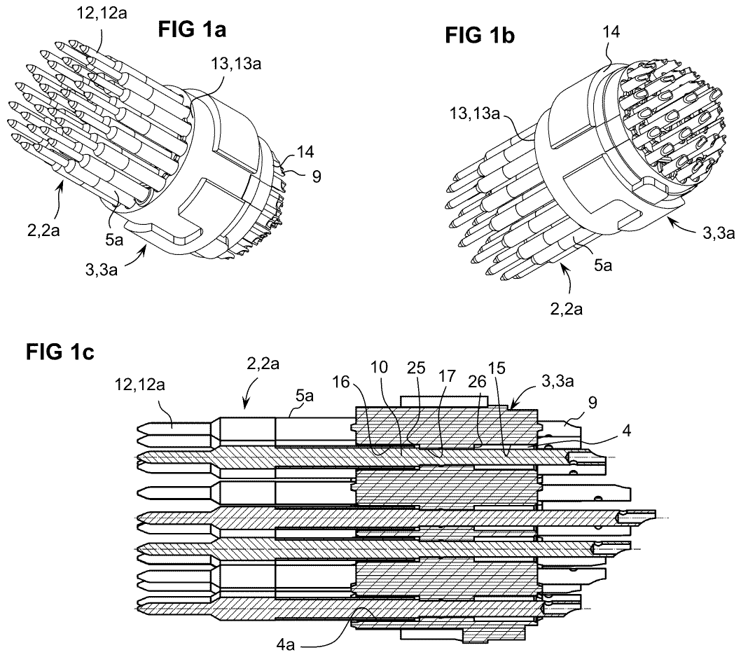

FIGS. 1a and 1b are perspective views of an inner part (without outer casing) of a first (male) connector according to an embodiment of the invention;

FIG. 1c is a cross-sectional view of the inner part of FIGS. 1a and 1b;

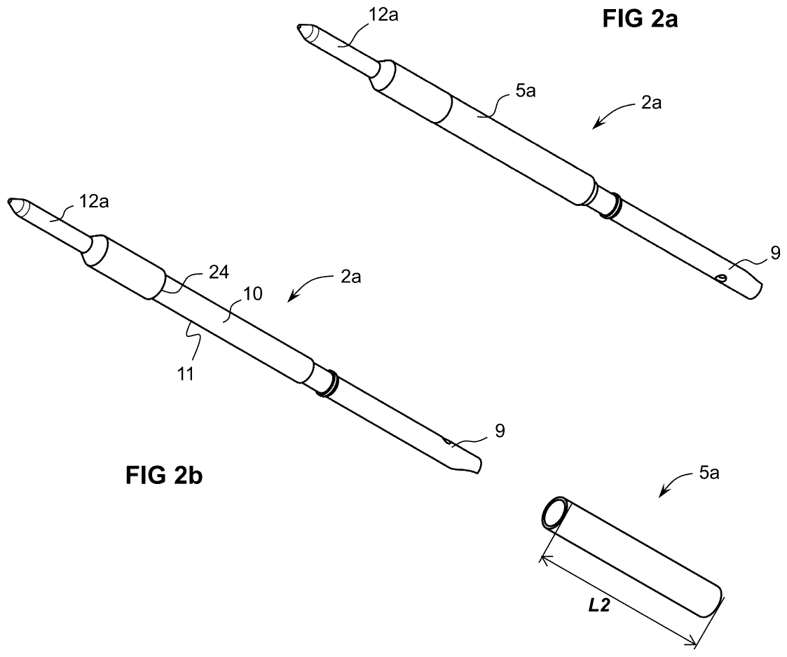

FIG. 2a is a perspective view of an electrical contact (pin contact) of the first connector;

FIG. 2b is an exploded perspective view of the electrical contact of FIG. 2a showing an insulating tube sleeve to be assembled to the contact;

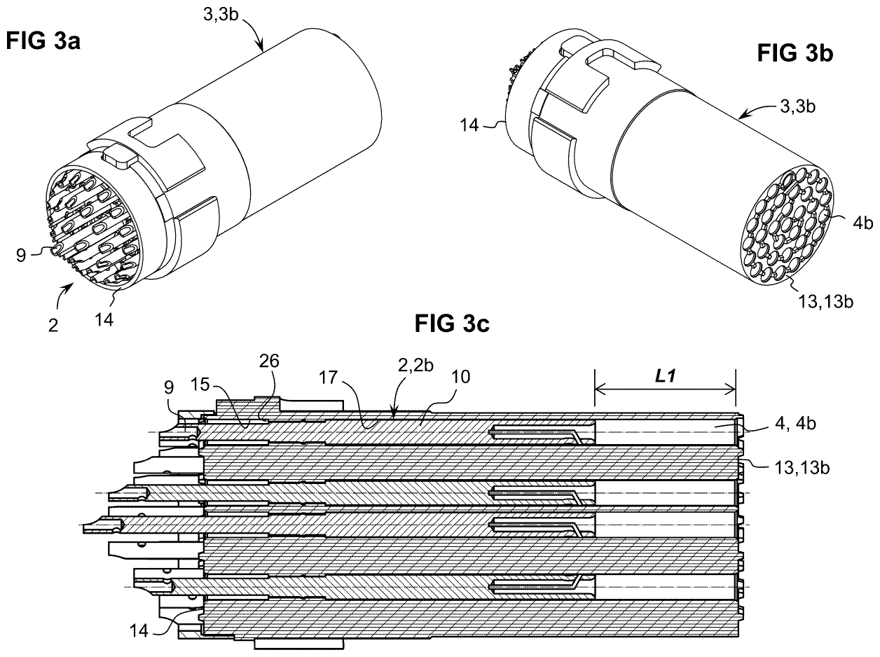

FIGS. 3a and 3b are perspective views of an inner part (without outer casing) of a second (female) connector according to an embodiment of the invention, for plugging connection to the first connector of FIGS. 1a to 1c;

FIG. 3c is a cross-sectional view of the inner part of FIGS. 3a and 3b;

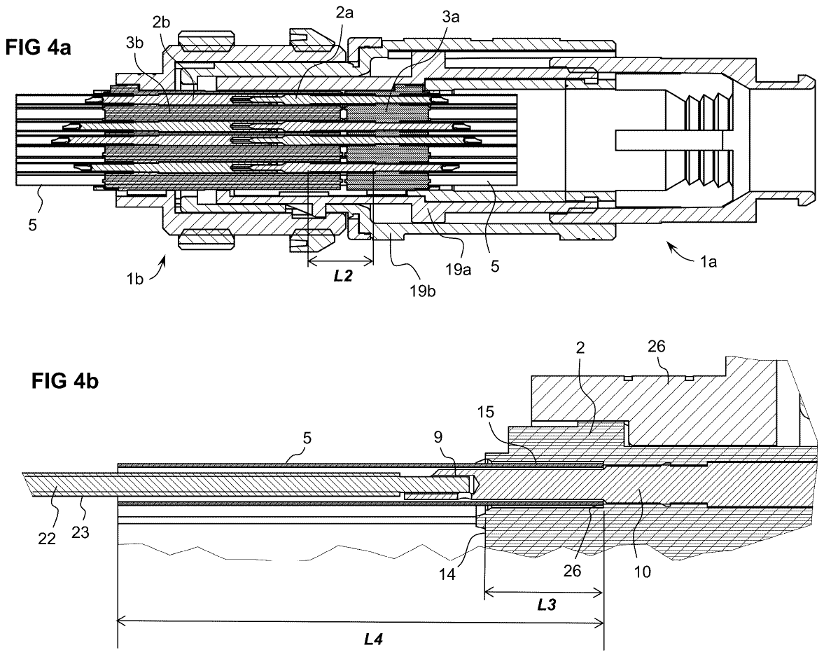

FIG. 4a is cross-sectional view through a first connector (comprising an insulating housing and contacts according to FIG. 1a to 1c) and a mating second connector (comprising an insulating housing and contacts according to FIGS. 3a to 3b);

FIG. 4b is a cross-sectional detail view of a portion of a connector according to an embodiment of the invention, showing a cabling side of the connector;

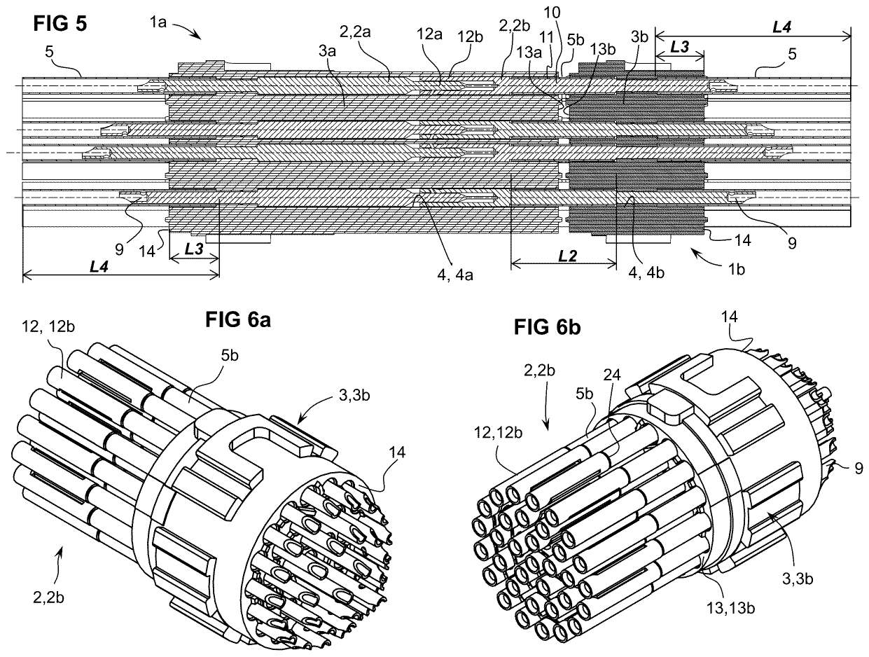

FIG. 5 is cross-sectional view through a first connector with pin contacts and a mating second connector with receptacle contacts according to another embodiment of the invention, in which the mating sections of the pin contacts are positioned within the contact receiving cavities of the first insulating housing and the receptacle contacts protrude out of the second insulating housing;

FIGS. 6a and 6b are perspective views of the connector with receptacle contacts of the embodiment of FIG. 5;

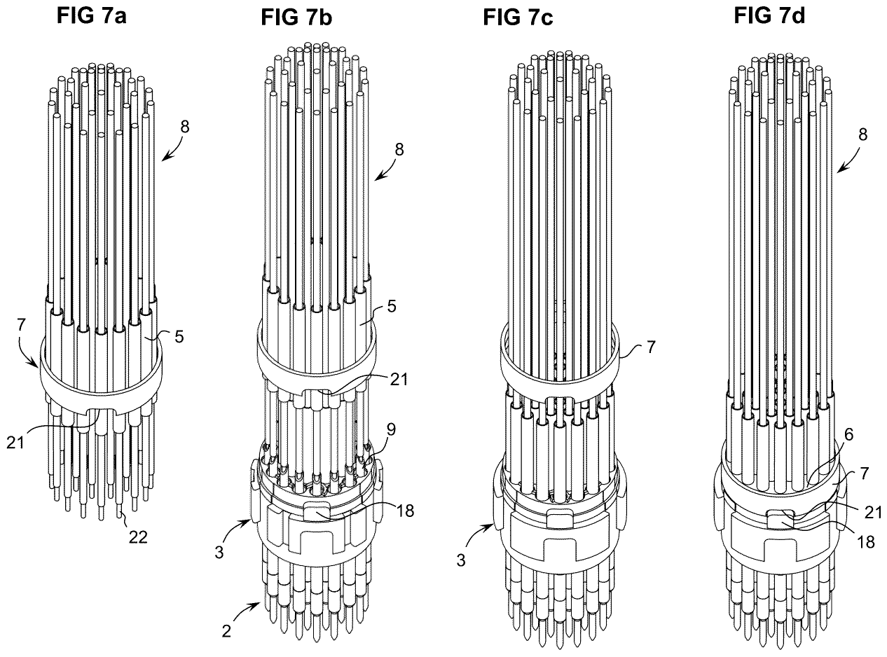

FIG. 7a is a perspective view of a cabling arrangement for connection to electrical contacts of an electrical connector according to an embodiment of the invention;

FIG. 7b is a view of the cabling arrangement of FIG. 7a in a first assembly step for connection to electrical contacts of the connector according to an embodiment of the invention;

FIGS. 7c and 7d are views similar to FIG. 7b showing subsequent assembly steps.

Referring to the figures, an electrical connector 1 comprises an insulating housing 3 and a plurality of electrical contacts 2 mounted in corresponding contact receiving cavities 4 formed within the housing.

The insulating housing 4 fixes the position of the electrical contacts and separates them by a certain distance required for electrical insulation. The electrical contacts may typically be secured in a substantially fixed manner within the housing by barbs or protuberances that have an interference fit with the housing or other per se well known means. The insulating housing may also be overmolded over a certain section of the electrical contacts. Alternatively, the electrical contacts may be inserted in the cavities of an already formed housing.

A casing 19a, 19b may be provided around the insulating housing 3, the casing serving various functions such as for guiding and locking the connector to a mating connector, gripping the cable connected to the connector, mounting of the connector and various structural and protective functions for the connector.

The electrical contacts 2 generally comprise a wiring end section 9 for connection to an electrical conductor, for instance a wire conductor 22 of an electrical wire 8, the wire being provided with an insulating layer 22 as per se well known, with an end exposed for crimping, soldering or welding connection to the wiring end section 9 of the electrical contact. The electrical contact further comprises a center body section 10 that is at least partially lodged and anchored in direct contact within the contact receiving cavity 4 of the housing, and a plugging end section 12 for plugging connection to a complementary contact.

A connector arrangement with first and second connectors 1a, 1b that may be pluggably mated together is illustrated in FIG. 4a.

The first connector 1a may comprise pin contacts 2a and the second connector 1b may comprise receptacle contacts 2b. The pin contacts 2a of the first connector 1a project beyond a mating side 13 of the first housing 3a. The receptacle contacts 2b of the second connector 1b however have a plugging end section 12b that is lodged within the receptacle contact receiving cavity 4b at a certain distance (first length) L1 from the mating side 13b of the second housing 3b. The first length L1 is preferably at least two times a diameter of the receptacle contact receiving cavity 4b. Thus, when the pin contact 2a is plugged into the receptacle contact 2b, a certain section of pin contact is inserted into the receptacle contact receiving cavity 4b which thus provides an insulation separation between adjacent pin contacts.

In another embodiment as illustrated in FIGS. 5, 6a, 6b, the first connector 1a comprises pin contacts 2a and the second connector 1b comprises receptacle contacts 2b, whereby the pin contacts 2a of the first connector 1a have a plugging end section 12a that is lodged within the pin contact receiving cavity 4a and the receptacle contacts 2b of the second connector 1b have a plugging end section 12b projecting beyond a mating side 13b of the second housing 3b. Thus, when the receptacle contact 2b is plugged onto the pin contact 2a, a certain section of receptacle contact is inserted into the pin contact receiving cavity 4a which thus provides an insulation separation between adjacent receptacle contacts.

The wiring end section 9 of the contacts 2 project outside of the housing 3, beyond a cabling side 14 of the housing 3. This allows the connector to be connected to electrical wires 8 after the contacts 2 have been assembled to the housing 3.

Referring to FIGS. 1a to 2b, the pin contact 2a further comprises a mating side insulating tube sleeve 5a inserted over a portion of the centre body section 10 of the pin contact 2a. The insulating tube sleeve 5a mounted on the pin contact 2a projects beyond the mating side 13a of the first housing 3a having a length configured to be partially inserted in the receptacle contact receiving cavity 4b when the first and second connectors are mated together. This ensures that the electrical path between adjacent electrical pin contacts is extended.

The pin contact 2a has a body section with a reduced diameter allowing the positioning of the insulating tube sleeve 5a to be inserted on the reduced section diameter up until it abuts a shoulder 24. The sleeve 5a is preferably flush with the outer diameter of the pin contact forward of the shoulder 24.

Referring to FIGS. 5 to 6b, the receptacle contact 2a in this variant comprises a mating side insulating tube sleeve 5b inserted over a portion of the centre body section 10 of the receptacle contact 2b. The insulating tube sleeve 5b mounted on the receptacle contact 2b projects beyond the mating side 13b of the second housing 3b having a length configured to be partially inserted in the pin contact receiving cavity 4a when the first and second connectors are mated together. This ensures that the electrical path between adjacent electrical pin contacts is extended.

The receptacle contact 2b has a body section 10 with a reduced diameter allowing the positioning of the insulating tube sleeve 5b to be inserted on the reduced section diameter up until it abuts a shoulder 24. The sleeve 5b is preferably flush with the outer diameter of the receptacle contact forward of the shoulder 24.

The insulating tube sleeve 5a, 5b which is assembled to the pin contact or receptacle contact (depending on the variant) by sliding over the body section, advantageously ensures an accurate position of the tube sleeve 5a, 5b relative to the contact, as well as ensuring a constant accurate thickness defined by the tube sleeve thickness, compared to an overmolded insulating layer that may have a varying thickness depending on manufacturing tolerances.

According to an aspect of the invention, the insulating tube sleeve 5a, 5b is preferably made of a polyimide tube which advantageously provides a high insulation resistance against electrical fields and moreover polyimide tubes can be formed with very accurate dimensions in particular in the thickness of the tube which may be made with very thin walls, for instance of less than 0.3 mm. This ensures that the insulating layer has an accurate constant thickness around the pin contact to ensure an electrical breakdown resistance within a small range of tolerances, despite the very thin wall of the insulating tube sleeve. Other suitable insulating tube materials that may be formed with very thin tube walls with accurate dimensions in particular in the thickness of the tube less than 0.3 mm, include Polytetrafluoroethylene (PTFE), glass, or ceramic tubes.

The length L2 of the insulating tube sleeve 5a, 5b which defines the length that spans from the receptacle contact receiving cavity 4b to the pin contact receiving cavity 4a, can be varied easily to adjust the electrical path according to the required specifications by the position of the shoulder on the pin contact and the length of the insulating tube sleeve 5a, 5b, compared to overmolding for instance.

Thus, the assembly of an insulating tube sleeve on the pin contact or receptacle contact (depending on the variant) allows greater flexibility in the manufacturing of connectors with different specifications. Moreover, the insertion of the insulating tube sleeve 5a, 5b from the wire end section, as opposed to an insertion from the plugging end section allows easy accurate positioning of the insulating tube sleeve on the pin contact or receptacle contact (depending on the variant) and in a secure manner because the insulating tube sleeve is locked between the contact shoulder 24 and a shoulder 25 in the pin receiving cavity 4a, 4b.

Referring in particular to FIGS. 4a and 4b, according to an aspect of this invention the electrical connector comprises a cabling side insulating tube sleeve 5 inserted over the wiring end section 9 of the electrical contact 2. The insulating tube sleeve 5 may advantageously be made of polyimide with the advantages as discussed above in relation to the insulating tube sleeve 5a, 5b on the mating side of the contact.

The contact receiving cavity 4 comprises an enlarged diameter section at the cabling side 14 extending into the housing over a tube insertion length L3 to form a spacing between the housing and the outer surface of the receptacle contact wiring end section 9, configured to allow insertion of the insulating tube sleeve 5 into the housing over the length L3. The insulating tube sleeve 5 has a length L4 that extends from inside the housing 3 to a position over the insulating layer 23 of the electrical wire 8 such that the interconnection between the conductor 22 and the wiring end section 9 of the electrical contact is fully covered and provides a long electrical path between the adjacent conductors. The length L4 of the insulating tube sleeve is preferably at least eight times a distance between adjacent contacts 2 to ensure a sufficiently long electrical path between contacts.

It may be noted that in certain embodiments only a portion of the plurality of the electrical contacts may be provided with insulating tube sleeves. For instance, only contacts that are configured to be connected to a high voltage may be provided with the insulating tube sleeves.

FIGS. 7a to 7d which illustrates steps in the assembly of the insulating tube sleeves 5 to the electrical contacts 2. In this example the wiring end sections 9 are of the pin contacts 2a, although the same procedure applies for the wiring end section of the receptacle contacts 2b.

The insulating tube sleeves 5 are inserted over the electrical wires 8 and passed through a filler containment ring 7 that serves to contain an insulating filler 6 as described hereafter. The insulating tube sleeves 5 are inserted over the wires 8 before the wires are connected to the respective contacts 2. FIG. 7b shows the electrical wires 8 connected (for instance by soldering) to the wire receiving sections 9 of the respective contacts 2. In a subsequent step, the insulating tube sleeves 5 are slidingly moved along the electrical wires towards the cabling side 14 of the housing 3 and further such that they are inserted into the respective cabling side tube receiving sections 15 until they abut the shoulders 26 in the tube receiving section 15.

The containment ring 7 may then be positioned against the cabling side 14 of the housing 3, optionally positioned by positioning members 18, 21 on the housing 3 and the containment ring 7. An epoxy resin or other insulating filler 6 material may then be poured or injected into the well area formed by the containment ring 7, around and in between the insulating tube sleeves 5. The insulating filler 6 is made of a resin (such as acrylate based or epoxy based resins) that is configured to form a bond between the material of the insulating tube sleeve 5 and the material of the housing 3.

### LIST OF REFERENCES USED

Electrical connector 1
First connector 1a, Second connector 1b
   Electrical contact 2
   Pin contact 2a, Receptacle contact 2b
      Wiring end section 9
      Centre body section 10
         Sleeve receiving section 11
      Plugging end section 12, 12a, 12b
         Shoulder 24
   Housing 3
   First housing 3a, second housing 3b
      Mating side 13, 13a, 13b
      Cabling side 14
      Contact receiving cavity 4
      Pin contact receiving cavity 4a, Receptacle contact receiving cavity 4b
         Cabling side tube receiving section 15
         Shoulder 26
         Mating side tube receiving section 16
         Shoulder 25
         Centre holding section 17
      Ring positioning member 18
   Wiring side insulating tube sleeve 5
   Mating side insulating tube sleeve 5a, 5b
      Polyimide tube
   Insulating filler 6
   Filler containment ring 7
      Positioning member 21
   Electrical wire/cable 8
      Conductor 22
      Insulating layer 23
   Casing 19, 19a, 19b
Distance of receptacle contact from mating face L1
Mating side insulating tube sleeve length L2
Depth of cabling side tube receiving section length L3
Wiring side insulating tube sleeve length L4

1.-25. (canceled)

26. Electrical connector comprising an insulating housing having contact receiving cavities extending between a mating side and a cabling side of the housing, a plurality of electrical contacts lodged in the contact receiving cavities and anchored in direct contact engagement with the contact receiving cavities, the electrical contacts having a plugging end section, a center body section and a wiring end section, the wiring end section projecting out of the housing beyond the cabling side for connection to conductors of electrical wires, wherein the contact receiving cavity comprises a cabling side tube receiving section having a diameter greater than a portion of the electrical contact so as to form a tubular gap between the electrical contact and the housing, the connector further comprising an insulating tube sleeve slidably inserted over the electrical wire, the insulating sleeve tube having a section extending into the cabling side tube receiving section and a section extending out of the housing beyond the cabling side overlying an insulating layer on the conductor.

27. The electrical connector according to claim 26, wherein the insulating tube sleeve is made of polyimide.

28. The electrical connector according to claim 26, further comprising an insulating filler deposited over the cabling side of the housing in between and around the insulating tube sleeves inserted in the cabling side tube receiving section of the housing.

29. The electrical connector according to claim 28, further comprising a filler containment ring mounted around the cabling side of the housing forming a well for injection, pouring or molding of the insulating filler.

30. The electrical connector according to claim 26, wherein a length (L4) of the insulating tube sleeve is at least eight times a distance between adjacent contacts.

31. The electrical connector according to claim 26, wherein the contact comprises a mating section extending beyond a mating side of the housing and a reduced diameter body section having a rearwardly facing shoulder, the contact further comprising a second insulating tube sleeve having a length (L2) inserted over the reduced diameter center body section, a portion of the insulating tube sleeve extending beyond a mating side of the housing, configured for insertion in a contact receiving cavity of a mating connector.

32. The electrical connector according to claim 31, wherein the diameter of a portion of the contact adjacent of the shoulder is substantially identical to a diameter of the second insulating tube sleeve such that the second insulating tube sleeve is flush with the contact at the interface between the insulating tube sleeve and the shoulder.

33. The electrical connector according to claim 31, wherein the electrical contacts include pin contacts, wherein the pin contact comprises the reduced diameter body section having a rearwardly facing shoulder and the second insulating tube sleeve inserted over the reduced diameter center body section, the portion of the second insulating tube sleevehaving a length (L2) of the second insulating tube sleeve extending beyond a mating side of the housing, configured for insertion in a receptacle contact receiving cavity of a mating connector.

34. The electrical connector according to claim 33, wherein the receptacle contacts having a plugging end sectionpositioned within the receptacle contact receiving cavity of the second housing spaced at a first length (L1) from a mating side of the second housing, said first length being at least two times a diameter of the receptacle contact receiving cavity.

35. The electrical connector according to claim 31, wherein the electrical contacts include receptacle contacts, wherein the receptacle contact comprises the reduced diameter body section having a rearwardly facing shoulder and the second insulating tube sleeve inserted over the reduced diameter center body section, the portion of the second insulating tube sleeve having a length (L2) of the second insulating tube sleeve extending beyond a mating side of the housing, configured for insertion in a pin contact receiving cavity of a mating connector.

36. The electrical connector according to claim 26, wherein the insulating tube sleeves have a tube wall thickness of less than 0.3 mm.

37. An electrical connector arrangement comprising a first connector and a second connector pluggably connectable together, the first connector and second connector having the characteristics of the electrical connector according to claim 26, wherein the first connector comprises pin contacts and the second connector comprises receptacle contacts.

38. A method of assembling an electrical connector according to claim 26, comprising:
inserting or overmolding the electrical contacts in the insulating housing,
inserting the insulating tube sleeves over at least some of the electrical wires,
connecting the conductors of the wires to the respective wire receiving portions of the contacts,
sliding the insulating tube sleeves over the respective wire receiving portions of the contacts and into the contact receiving cavities,
depositing an insulating filler over the cabling side of the housing in between and around the insulating tube sleeves.

39. Electrical connector comprising an insulating housing having contact receiving cavities extending between a mating side and a cabling side of the housing, a plurality of electrical contacts lodged in the contact receiving, the electrical contacts having a plugging end section, a center body section and a wiring end section, the wiring end section projecting out of the housing beyond the cabling side for connection to conductors of electrical wires, wherein the contact receiving cavity comprises a cabling side tube receiving section having a diameter greater than a portion of the electrical contact so as to form a tubular gap between the electrical contact and the housing, the connector further comprising an insulating tube sleeve slidably inserted over the electrical wire, the insulating sleeve tube having a section extending into the cabling side tube receiving section and a section extending out of the housing beyond the cabling side overlying an insulating layer on the conductor, and wherein the contact comprises a mating section extending beyond a mating side of the housing and a reduced diameter body section having a rearwardly facing shoulder, the contact further comprising a second insulating tube sleeve having a length (L2) inserted over the reduced diameter center body section, a portion of the insulating tube sleeve extending beyond a mating side of the housing, configured for insertion in a contact receiving cavity of a mating connector.

40. The electrical connector according to claim 39, wherein the insulating tube sleeve is made of polyimide.

41. The electrical connector according to claim 39, further comprising an insulating filler deposited over the cabling side of the housing in between and around the insulating tube sleeves inserted in the cabling side tube receiving section of the housing.

42. The electrical connector according to claim 41, further comprising a filler containment ring mounted around the cabling side of the housing forming a well for injection, pouring or molding of the insulating filler.

43. The electrical connector according to claim 39, wherein a length (L4) of the insulating tube sleeve is at least eight times a distance between adjacent contacts.

44. The electrical connector according to claim 39, wherein the diameter of a portion of the contact adjacent of the shoulder is substantially identical to a diameter of the second insulating tube sleeve such that the second insulating tube sleeve is flush with the contact at the interface between the insulating tube sleeve and the shoulder.

45. The electrical connector according to claim 39, wherein the electrical contacts include pin contacts, wherein the pin contact comprises the reduced diameter body section having a rearwardly facing shoulder and the second insulating tube sleeve inserted over the reduced diameter center body section, the portion of the second insulating tube sleeve having a length (L2) of the second insulating tube sleeve extending beyond a mating side of the housing, configured for insertion in a receptacle contact receiving cavity of a mating connector.

46. The electrical connector according to claim 45, wherein the receptacle contacts having a plugging end section positioned within the receptacle contact receiving cavity of the second housing spaced at a first length (L1) from a mating side of the second housing, said first length being at least two times a diameter of the receptacle contact receiving cavity.

47. The electrical connector according to claim 39, wherein the electrical contacts include receptacle contacts, wherein the receptacle contact comprises the reduced diameter body section having a rearwardly facing shoulder and the second insulating tube sleeve inserted over the reduced diameter center body section, the portion of the second insulating tube sleeve having a length (L2) of the second insulating tube sleeve extending beyond a mating side of the housing, configured for insertion in a pin contact receiving cavity of a mating connector.

48. The electrical connector according to claim 39, wherein the insulating tube sleeves have a tube wall thickness of less than 0.3 mm.

49. An electrical connector arrangement comprising a first connector and a second connector pluggably connectable together, the first connector and second connector having the characteristics of the electrical connector according to claim 39, wherein the first connector comprises pin contacts and the second connector comprises receptacle contacts.

50. A method of assembling an electrical connector according to claim 39, comprising:
inserting or overmolding the electrical contacts in the insulating housing,
inserting the insulating tube sleeves over at least some of the electrical wires,
connecting the conductors of the wires to the respective wire receiving portions of the contacts,
sliding the insulating tube sleeves over the respective wire receiving portions of the contacts and into the contact receiving cavities,
depositing an insulating filler over the cabling side of the housing in between and around the insulating tube sleeves.
